(19) United States
(12) Patent Application Publication
(10) Pub. No.: US 2026/0183850 A1
(43) Pub. Date: Jul. 2, 2026

(54) TWO-FLUTE DEEP-HOLE DRILL FOR STAINLESS STEELS AND OTHER HIGH-ALLOY STEEL MATERIALS

(71) Applicant: botek Präzisionsbohrtechnik GmbH, Riederich (DE)

(72) Inventors: Heinrich BAUMGAERTNER, Bad Urach (DE); Magnus TESCHNER, Pfullingen (DE)

(73) Assignee: botek Präzisionsbohrtechnik GmbH, Riederich (DE)

(21) Appl. No.: 19/544,437

(22) Filed: Feb. 19, 2026

Related U.S. Application Data
(63) Continuation of application No. PCT/EP2024/071152, filed on Jul. 25, 2024.

(30) Foreign Application Priority Data
Aug. 22, 2023 (DE) 10 2023 122 498.0

(51) Int. Cl. B23B 51/06; B23B 51/00

(52) U.S. Cl. CPC B23B 51/066; B23B 51/0002; B23B 2251/204; B23B 2251/40; B23B 2251/443

(57) ABSTRACT

A two-flute drill for machining stainless steels and other high-alloy steel materials, the flutes of which are curved in cross section. The two-flute drill has a shank and a drill head. Two main cutting edges, two secondary cutting edges, two circular grinding chamfers, at least one guide chamfer, and two straight flutes are formed on the drill head.

This nonprovisional application is a continuation of International Application No. PCT/EP2024/071152, which was filed on Jul. 25, 2024, and which claims priority to German Patent Application No. 10 2023 122 498.0, which was filed in Germany on Aug. 22, 2023, and which are both herein incorporated by reference.

### BACKGROUND OF THE INVENTION

### Field of the Invention

The present invention relates to a two-flute deep-hole drill that is especially suitable for cutting stainless steels and other high-alloy steel materials.

### Description of Background Art

Two-flute deep-hole drills or two-flute drills are known from the prior art in various embodiments. Fundamentally, efforts are always being made to improve tool life travel, machining accuracy, and process reliability of deep-hole drills.

Drill heads are almost always made of carbide nowadays. Often, the shank of the drill is also made of carbide (so-called solid carbide drills).

High process reliability requires short or compactly shaped chips, because only chips of this nature can be reliably transported out of the drilled hole through the flutes of the tools.

When deep drilled holes are to be made in long-chipping materials, it accords with the prior art to install chip breakers and/or chip formers on the tool in order to produce compact chips and to ensure reliable chip removal from the drilled hole. Chip breakers have a discontinuous tool cutting edge. This has the disadvantage of costly tool manufacture. Moreover, the edges of the chip breaker geometry are especially susceptible to chipping, which can lead to sudden failure of the tool.

Chip formers generally cause an increase in the feed and cutting forces, which can adversely affect the hole path. Moreover, their manufacture is costly.

Single-flute drills are ideally suited tools for making high-quality drilled holes with depths greater than 5−10×D in steel materials with high process reliability. When stainless steels are drilled with single-flute drilling tools using water-miscible cutting fluid, however, an undesirable effect occurs that sharply reduces the tool life travel of the drilling tool: The alloying constituents nickel and chromium have a strong affinity for the tungsten contained in the carbide of the drill head. This affinity causes the tungsten to be leached out of the carbide. In consequence, the carbide is structurally weakened, and high wear occurs, in particular at the guide pads of the drill head. As a result, the surface finish of the hole wall is significantly degraded and the tool life travel of the drill often is only 1 meter to 2 meters. On account of the very pronounced wear on the guide pads, oftentimes regrinding also is no longer possible.

If drilling oil is used as cutting fluid, this phenomenon is far less pronounced, so that deep drilled holes can be made by means of single-flute drills with high process reliability. However, much machining equipment, in particular the widely used machining centers, is generally operated with water-miscible cutting fluids (emulsions).

Twist drills and two-flute drills are symmetrical tools, by which means the loading of the guide pads or guide chamfers is significantly lower and the phenomenon of severe guide chamfer wear is significantly less. On account of chip removal with these tools, it frequently is not possible to make deep drilled holes with high process reliability in stainless steel materials, in particular from the group of austenites, so that stress-relief strokes are necessary. Also, postprocessing, for example by means of reaming, is frequently necessitated by the surface finish that can be produced as well as by the achievable diameter tolerance. This increases the process times as well as the process costs. Furthermore, deep hole twist drills are expensive to manufacture as well as to regrind.

Known from JP S63102814 is a two-flute drill with a straight flute or groove. In this drill, the flutes or the grooves are delimited by a narrow and flat rake face and a narrow and flat wall. The narrow, flat rake face and the narrow, flat wall each form a narrow strip that runs parallel to the central axis of the drill. The flat rake face and the flat wall extend radially. Between the flat rake face and the flat wall, the flute has a curved cross section. This cross section of the flute is restricted to the drill head; in the region adjacent to the drill head, the flutes have a different cross section.

### SUMMARY OF THE INVENTION

It is therefore an object of the present invention to provide a two-flute deep-hole drill that has a long tool life travel and removes chips with high process reliability even when cutting stainless steels with water-miscible cutting fluids. In addition, the drilled holes produced with this drill should be very dimensionally accurate, have a small straightness deviation, and produce good surface finishes. The feed and cutting forces should be small to the extent possible. Furthermore, the two-flute deep-hole drill according to the invention should be relatively easy to manufacture and regrind.

The flute according to an example of the invention causes the main cutting

edges to be curved from the cutting edge corners to the secondary cutting edge. Consequently, a “draw” cut results, and the drill centers itself very well in the drilled hole.

Unlike with JP S63102814, in which the main cutting edge comprises a short, straight, radially extending section and an adjacent curved section, with the drill according to the invention the chip is formed continuously from outside to the point of the drill. This has the surprising and positive effect that wear decreases sharply and the tool life travel increases sharply. It is surmised that the shape according to the invention of the cutting edges brings about a very good centering of the drill, and consequently the contact pressure between the circular grinding chamfers and the guide chamfers on the one hand and the drilled hole on the other hand is reduced.

A further improvement in the performance characteristics of the two-flute drill according to the invention becomes apparent, surprisingly, when one of the guide chamfers is arranged on the same radius as the circular grinding chamfers, while the other guide chamfer is arranged on a somewhat smaller radius (R−Δx) than the circular grinding chamfers. It has proven to be sufficient when one of the two guide chamfers is arranged on a radius that is at least 3/100 mm smaller than the circular grinding chamfers (Δx is greater than or equal to 0.03 mm and less than or equal to 0.1 mm).

A setback by more than 1/10 mm is not necessary. This positive effect can be explained by the circumstance that the drill is centered very well and guided in the drilled hole by the two circular grinding chamfers and the one guide chamfer that are arranged on the same radius as the circular grinding chamfers. The guide chamfer that is set back ensures that the drill does not bind in the drilled hole. Moreover, a relatively thick and very stable hydrodynamic lubricating wedge, which also has good damping properties, is formed between the drilled hole and the set-back guide chamfer.

These positive effects can also be utilized in a two-flute drill With this design, as well, a two-flute drill is obtained that is distinguished by a long tool life travel and that very accurately produces drilled holes with good surface and low straightness deviation.

The features of the invention can also be combined with one another. They result in a two-flute drill that, in practical tests in austenitic stainless steel 1.4301 with water-miscible cutting fluids, had a tool life travel of significantly more than 50 meters without exhibiting appreciable wear.

A further improvement in the performance characteristics is achieved when a tangent T of the curved region of the flute at the cutting edge corner and a radial ray RS through the cutting edge corner enclose an angle β greater than 0°. It has proven to be sufficient when the angle β is less than 10°; preferably it is 2° or 5°.

In another example of the two-flute drill according to the invention, a circumferential angle γ of the flutes is less than 90°. The circumferential angle γ is a measure of the width of the flutes.

The guide chamfers can be arranged offset from the circular grinding chamfers by an angle of more than 80° and less than 100°.

It has proven advantageous when the cross section of the flutes in the two-flute drills according to one of the preceding claims is the same in the region of the drill head and in the region of the shank. In this way, a build-up of chips at the transition between different cross sections of the flutes is avoided, and the process reliability is increased.

It has also proven successful when a radius of curvature of the flutes is not constant. Especially preferably, the radius of curvature is greatest at the cutting edge corner. This can be achieved, for example, by the means that a grinding wheel is used that has a profile in the shape of a circular segment. The desired profile of the flute can be produced in a simple manner by inclining or pivoting this grinding wheel.

It is likewise possible in this way to set an angle β that is greater than 0° between a tangent T of the curved cross section of the flute at the cutting edge corner and a radial ray RS through the cutting edge corner.

The two-flute drill according to the invention can be designed as a solid carbide drill or as an assembled drill with a drill head soldered onto the shank.

The two-flute deep-hole drill according to the invention is relatively simple to manufacture. One of the reasons for this is that the flutes are straight and the rake face according to the invention can be produced in one grinding operation with a profiled (and potentially pivoted) grinding wheel.

The drill head according to the invention can be made of carbide and can be coated if necessary.

Because of the continuously curved main cutting edges and/or the one slightly set-back guide chamfer, the two-flute drill according to the invention has very good performance characteristics. The two measures can be implemented individually or in combination on a two-flute drill.

All features described in the drawings, the description thereof, and the claims can be essential to the invention both individually and in any desired combination with one another.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a two-flute deep-hole drill according to the invention,

FIG. 2 is a detail X of the drill point from FIG. 1, and

FIG. 3 is a view from the front of a drill head according to the invention.

### DETAILED DESCRIPTION

In FIG. 1, a two-flute deep-hole drill 1 is depicted schematically and in a somewhat simplified manner. The deep-hole drill 1 is formed of a drill head 11, a shank 12, and a clamping shank 13. By means of the clamping shank 13, the deep-hole drill 1 is held in a deep-hole drilling machine or a machining center. The drill head according to the invention can be used in solid carbide tools as well as in “assembled” tools. In the case of “assembled” tools, a drill head, a tubular shank, and a clamping sleeve are soldered together.

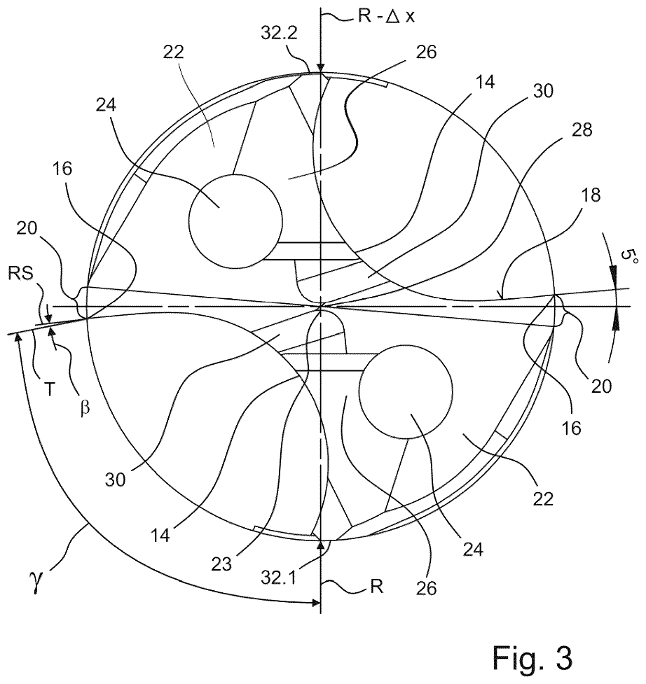

A rotational axis or the central axis of the drill head 11 is labeled with reference symbol 23. Formed in the drill head 11 and the shank 12 are two grooves or flutes 14. Details of the geometry of the flutes 14 are explained further below on the basis of FIG. 3.

As can be seen from the detail “X,” this exemplary embodiment has a point angle of 150°. Point angles between 120° and 170° are readily possible.

It is also possible to provide a skiving chamfer so that the drill has a smaller point angle in an outer region. In the region of the skiving chamfer, the point angle can be between 60° and 140°.

The deep-hole drill 1 according to the invention is especially suitable for drilling stainless, high-alloy, and ductile steels. This is a very demanding application, since these steels, in particular their alloying constituents nickel and chromium, have the undesirable property of leaching out the tungsten contained in the carbide drill head, thereby accelerating wear of the drill head. This property is especially pronounced when the drilled hole is lubricated with an emulsion of water and drilling oil.

In order to prevent this, multiple measures are provided in accordance with the invention that are explained below, primarily on the basis of FIG. 3.

In cross section, which is to say in a plane extending perpendicular to the central axis 23, the flute 14 according to the invention has a curved shape. In this exemplary embodiment, the radius of curvature of the flute 14 is greatest at the cutting edge corner 16.

The cutting edge corner 16 is the place where a main cutting edge 18 and a circular grinding chamfer 20 meet.

A further improvement in the performance characteristics is achieved when a tangent T of the curved region of the flute 14 at the cutting edge corner 16 and a radial ray RS through the cutting edge corner 16 enclose an angle β greater than 0°. It has proven to be sufficient when the angle β is less than 10°; preferably it lies in a range from 2° to 5°.

Two cooling lubricant channels 24 are visible at the point of the drill head 11. These cooling lubricant channels 24 extend over the entire length of the deep-hole drill 1 in a manner that is known per se. Cooling lubricant is carried to the point of the deep-hole drill 1 by the cooling lubricant channels 24. The cooling lubricant cools the drill point and at the same time conveys the chips produced by the drill head 11 through the flutes 14 toward the clamping sleeve 13.

In order to support removal of the chips, cutting fluid flutes 26 that create a direct hydraulic connection between the cooling lubricant channels 24 and the flutes 14 can be ground into the end flanks 22. The volume flow rate of the cooling lubricant flowing from the cooling lubricant channels 24 into the flutes 14 can be set by means of the cross section of the cutting fluid flutes 26.

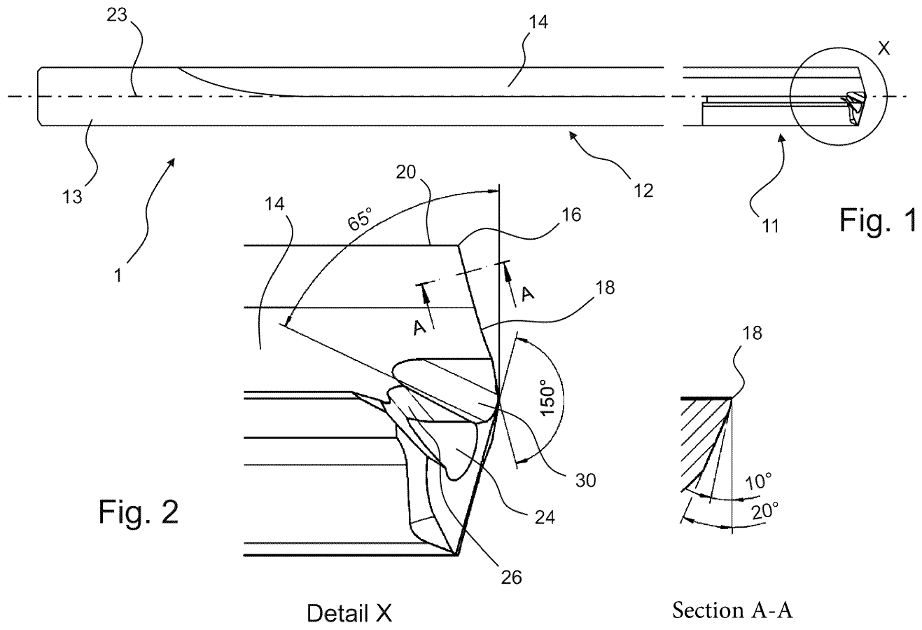

As can be discerned with the aid of FIG. 3, the point of the drill head is “web-thinned.” “Web thinning” is carried out by making two ground surfaces 30 in the drill point that shorten a chisel edge 28 of the drill. The feed forces are reduced by means of the web thinning. The flutes 26 and the ground surfaces 30 are also visible in FIG. 2.

Section A-A in FIG. 2 shows an advantageous embodiment of the flank. Adjoining the main cutting edge 18, the clearance angle is 10°. Adjacent thereto, the clearance angle is increased to 20°. Of course, the invention is not limited to these clearance angles.

The arrangement according to the invention of the circular grinding chamfers and the guide chamfers is now explained on the basis of FIG. 3.

The drill head includes two circular grinding chamfers 20, which are arranged on the cutting edge corners 16. Two guide chamfers 32 are formed at an offset of approximately 90° in the circumferential direction from the circular grinding chamfers 20.

The lower guide chamfer 32.1 in FIG. 3, like the circular grinding chamfers 20 as well, is spaced apart from the central axis 23 by a distance R corresponding to half the diameter of the drill.

The upper guide chamfer 32.2 in FIG. 3 is positioned somewhat closer to the central axis 23 (“set back”) as compared with the circular grinding chamfers 20 and the guide chamfer 32.1. The guide chamfer 32.2 can be set back by an amount Δx from 3/100 mm to approximately 1/10 mm.

It is then ensured that the drill can turn freely in the drilled hole and does not bind. Moreover, a lubricating film (from approximately 3/100 mm to approximately 1/10 mm thickness) forms between the hole wall and the guide chamfer 32.2, which has a beneficial effect on the wear characteristics of the drill.

Namely, if the contact pressure rises between the guide chamfer 32.1, which is positioned on the same radius as the circular grinding chamfers 20, and the hole wall, then the drill head can “deflect” a little in the direction of the guide chamfer 32.2. Consequently, the contact pressure between the guide chamfer 32.1 and the hole wall decrease [sic; should be singular]. This reduces wear substantially. A deflection by as little as 1/100 mm to 2/100 mm can suffice.

In addition, the lubricating film between the hole wall and the guide chamfer 32.2 has a damping effect, which likewise has a positive effect on the quality of the drilled hole and the tool life travel of the drill.

On account of the flutes 14 that are curved in cross section, the two-flute drill according to the invention has curved main cutting edges 18.

Both because of the continuously curved main cutting edges 18 and/or [sic] the one slightly set-back guide chamfer 32.2, the two-flute drill according to the invention has very good performance characteristics. The two measures can be implemented individually or in combination on a two-flute drill.

Two-flute drills are a specialized variant of deep-hole drilling tools. Deep-hole drilling tools can be understood to be tools that operate in accordance with various known deep-hole drilling systems, i.e., BTA, ejector, single-flute drills, etc.

Two-flute drills are long and slender and have a central axis. The drill point coincides with the rotational axis of the two-flute drill. As a result, the drill point centers the drill in the drilled hole.

Two-flute drills are normally used in a diameter range from approximately 3 mm to 40 mm. Drilled holes with a length up to approximately 6,000 mm are possible.

Two-flute drills are distinguished in that a drilled hole with high quality can be produced in a single stroke. They can be used in machine tools such as, e.g., lathes, machining centers, or specialized deep-hole drilling machines.

The cutting process is accomplished by a motion of the drill relative to the workpiece in a direction of rotation about a common central axis or rotational axis as well as a relative motion of the drill in the direction of the rotational axis (feed motion). The rotational motion can be carried out by the drill and/or the workpiece. The same applies to the feed motion.

The deviation [mm] of the actual hole path from the theoretical central axis of the drill during the drilling process is regarded as the straightness deviation. Straightness deviation is an aspect of the hole quality. Efforts are made to achieve the smallest possible straightness deviation. In the ideal case, no straightness deviation occurs at all.

Straightness deviation depends on factors including whether the rotational motion is carried out by the drill or the workpiece or by both. Experience shows that the smallest straightness deviation values are achieved when the rotational motion is carried out by the workpiece or by the workpiece and drill.

Cooling lubricant (oil or emulsion), or a mixture of cooling lubricant and air (minimum quantity lubrication), for lubricating and cooling the drill head and the guide pads is conveyed through the cooling channels present in the drill shank and in the drill point. In addition, the cooling lubricant carries the chips that are produced by the main cutting edges away through the flutes.

The coolant is supplied at the back end under pressure (for example, at 75 bar), passes through the cooling channel, and exits at the drill head or at the drill point. The pressure is dependent on the diameter and on the length of the drill.

The drill head of a two-flute drill has two main cutting edges; several cutting edges can also be present. The cutting edge is the region that is involved in cutting; it is composed of the rake face and the flank. The rake face is the region on which the chip emerges. In the case of the two-flute drill according to the invention, the flute is curved in cross section (which is to say in a plane whose normal vector is parallel to the central axis of the drill). Consequently, the main cutting edges/the tool cutting edges are also curved. This results in a “draw” cut and reduces the cutting forces.

In the case of a two-flute drill, the main cutting edges or cutting edges extend from the central axis of the drill head to its outside diameter.

The flank is the surface at the point of the drill head that is opposite the machined workpiece surface. A drill that has become dull is made sharp again by grinding the flanks.

The tool cutting edge or (main) cutting edge is the line of contact between rake face and flank. If the point of the two-flute drill according to the invention has one conical and one or more frustoconical sections (e.g., a skiving chamfer), then each cutting edge of the two-flute drill according to the invention is composed of two or more curved partial cutting edges.

The overall shape of all cutting and non-cutting surfaces at the end face of the drill head is referred to as the ground surface. This also includes surfaces that do not directly adjoin the tool cutting edges, for example surfaces or flutes for guiding the coolant flow or also additional flanks or a web thinning for reducing the feed force.

The ground surface determines the shaping of the chips to a great extent, and is matched to the material to be machined. The goals of the matching in this regard include the shaping of chips that are as favorable as possible, a high machining speed, the longest possible service life of the drill, and meeting the required quality characteristics of the drilled hole such as, e.g., diameter, surface, or straightness (straightness deviation).

The drill head is made of a material suitable for cutting, generally carbide, but also cermet, ceramic, or other suitable materials.

Sintered carbide with the constituents tungsten carbide and cobalt is generally used as carbide.

The cutting edges of the drill wear owing to the cutting of the workpiece. A drill that has become dull can be reconditioned by regrinding. Regrinding means a redressing/grinding of the worn part of the drill head at the end face until all worn areas (in particular of rake face and flank) have been removed, and new, sharp cutting edges are produced again. After that, the ground surface has its original form once again. If necessary, a coating is applied at least to the point of the drill head after the regrinding. The drill then has the same characteristics as a brand-new drill.

A drilling tool can be reground repeatedly until a complete ground surface can no longer be produced on the drill head or until adequate guidance of the tool is no longer provided due to the shortening of the guide chamfers and guide pads.

To increase the service life, the drill head can be provided with a coating as wear protection, generally from the metal nitride or metal oxide groups, also in multiple alternating layers. The thickness is normally approximately 0.0005 to 0.010 mm. The coating is accomplished by chemical or physical vacuum coating processes. The coating can be provided on the circumference of the drill head, on the flanks, or on the rake faces, in some cases the entire drill head can also be coated.

During regrinding, the coating is removed by the grinding wheel, at least from the surfaces that are reground. The coating is retained on the other areas of the ground surface.

Two circular grinding chamfers are arranged on the circumference of a two-flute drill. In the case of a two-flute drill, they serve to guide the drill in the drilled hole; they also smooth the wall of the drilled hole. The circular grinding chamfers are cylindrical segments that are arranged at a distance of the radius R (corresponding to half the nominal diameter of the drill) from the central axis; they are in contact with the hole wall during the drilling process.

In the case of the two-flute drill according to the invention, two circular grinding chamfers and two guide chamfers are provided. In this design, circular grinding chamfers and two guide chamfers alternate.

Formed on the drill head between a circular grinding chamfer and a guide chamfer as well as between a guide chamfer and a circular grinding chamfer are radially set-back segments that have a smaller diameter, so that a gap arises there between the hole wall and the drill head. The gap serves to accumulate coolant for cooling and lubricating the circular grinding chamfer and the guide chamfer.

The line of contact (edge) between rake face and circular grinding chamfer is referred to as a secondary cutting edge. It runs parallel to the central axis of the drill.

The point of intersection between main cutting edge and secondary cutting edge is referred to as a cutting edge corner.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A two-flute drill comprising:
a shank; and
a drill head,
wherein two main cutting edges, two secondary cutting edges, two circular grinding chamfers, at least one guide chamfer, and two straight flutes are formed on the drill head,
wherein the two flutes have a curved region in cross section, and
wherein the curved region of the flutes extends to the secondary cutting edges.

2. The two-flute drill according to claim 1, further comprising a second guide chamfer, and wherein one of the guide chamfers is arranged on a same radius as the circular grinding chamfers and the other guide chamfer is arranged on a smaller radius than the circular grinding chamfers.

3. A two-flute drill comprising:
a shank; and
a drill head,
wherein two main cutting edges, two secondary cutting edges, two circular grinding chamfers, at least one guide chamfer, and two straight flutes are formed on the drill head, and
wherein one guide chamfer is arranged on a same radius as the circular grinding chamfers.

4. The two-flute drill according to claim 3, further comprising a second chamfer arranged on a smaller radius than the circular grinding chamfers.

5. The two-flute drill according to claim 3, wherein the flutes have a curved region in cross section, and wherein the curved region of the flutes extends to the secondary cutting edges.

6. The two-flute drill according to claim 3, wherein a tangent of the curved region of the flute at the cutting edge corner and a radial ray through the cutting edge corner enclose an angle greater than 0°.

7. The two-flute drill according to claim 3, wherein the angle is less than 10°.

8. The two-flute drill according to claim 3, wherein a circumferential angle of the flutes is less than 90°.

9. The two-flute drill according to claim 3, wherein the guide chamfers are arranged offset from the circular grinding chamfers by an angle of more than 80° and less than 100°.

10. The two-flute drill according to claim 3, wherein one of the guide chamfers is set back at least by 3/100 mm and at most by 10/100 mm compared with the circular grinding chamfers.

11. The two-flute drill according to claim 3, wherein a cross section of the flutes is the same in a region of the drill head and in a region of the shank.

12. Two-flute drill according to claim 3, wherein a radius of curvature of the flutes is not constant.

13. The two-flute drill according to claim 12, wherein a radius of curvature is greatest at the cutting edge corner.

14. The two-flute drill according to claim 3, wherein no chip formers are present on the main cutting edges.

15. The two-flute drill according to claim 3, wherein the main cutting edges are curved.

16. The two-flute drill according to claim 3, wherein the drill head is soldered onto the shank, and wherein the flutes in the region of the shank have a curved region.
